(19) United States
(12) Patent Application Publication
(10) Pub. No.: US 2013/0180444 A1
(43) Pub. Date: Jul. 18, 2013

(54) OFFSHORE WIND TURBINE INSTALLATION VESSEL

(71) Applicants: Peter Graham Harris, Aberdeen (GB); David N. Edelson, Wallis, TX (US)

(72) Inventors: Peter Graham Harris, Aberdeen (GB); David N. Edelson, Wallis, TX (US)

(73) Assignee: TECHNIP FRANCE, Courbevoie (FR)

(21) Appl. No.: 13/825,648

(22) PCT Filed: Aug. 26, 2011
(86) PCT No.: PCT/US11/49343

§ 371 Date: Mar. 22, 2013

Related U.S. Application Data
(60) Provisional application No. 61/386,307, filed on Sep. 24, 2010.

(51) Int. Cl. F03D 1/00

(52) U.S. Cl. CPC F03D 1/005
USPC 114/365; 405/203

(57) ABSTRACT

The disclosure provides a vessel with a double pontoon arrangement joined together with a central bridge creating an offset “H” arrangement. The bridge spans the pontoons and includes a gantry structure on top of which sits a lifting system. Articulated tugs provide accommodation, propulsion, and power to the main part of the installation vessel. Additional lifting devices can be installed within the gantry to provide further lifting capability. At least two stabilizing legs are provided along each pontoon. Once set up onsite, the stabilizing legs can be deployed to the seabed to lift the installation vessel up a short distance to apply load stability during lifting operations. Seabed piles, mast elements, and turbine elements are delivered by barges that are temporarily moored between the pontoons for offloading and installation. Empty barges are relocated, and successive barges bring remaining elements for offloading and installation to complete the wind turbine installation.

### CROSS REFERENCE TO RELATED APPLICATIONS

This application is an international application which claims the benefit of U.S. Provisional Application No. 61/386,307 filed Sep. 24, 2010.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The disclosure relates a vessel system and method for installing a structure in water, and more specifically, for installing an offshore wind turbine.

2. Description of the Related Art

Currently, wind turbines that are installed offshore typically involve the use of cranes to lift the tower, turbine, and turbine blades into position. Offshore crane barges and services are expensive. Moreover, typical offshore installations require several vessels for each operation, adding to the cost. When considering multiple turbine units, the multiple lifts, multiple crews, and crane assets deployed, the cost of offshore installations is considerably higher compared to land-based installations. The significantly higher costs affects the overall commercial viability of offshore wind turbine installations.

Specifically designed and purpose built offshore wind turbine vessels are common in Europe, but are nonexistent in the US. European vessels are unable to work in the US due to the restriction of the Jones Act, which requires that the vessel be built in the US. Thus, new US-built vessels are required and these are expensive, creating a vacuum in available options for offshore installations.

Moreover, articulated tug barges are common in the Gulf of Mexico. The stern of the barge has a female notch arrangement into which fits the bow of the tug. The articulated tug barge has an articulated or “hinged” connection system between the tug and barge, which allows movement in one axis, or plane in the critical area of fore and aft pitch. The tug is typically secured in place with hydraulic pins and allows the tug and barge to articulate in the vertical plane. This arrangement is also common with tankers. The tug can propel and maneuver the barge or tanker between locations and then detach therefrom.

Thus, there remains a need for an improved system and method for installing a structure in water, and particularly, for installing an offshore wind turbine.

### BRIEF SUMMARY OF THE INVENTION

The disclosure provides a vessel with a double pontoon arrangement joined together with a central bridge creating an offset “H” arrangement. The bridge spans the pontoons and includes a gantry structure on top of which sits a lifting system. Articulated tugs provide accommodation, propulsion, and power to the main part of the installation vessel. Additional lifting devices can be installed within the gantry to provide further lifting capability. At least two stabilizing legs are provided along each pontoon. Once set up onsite, the stabilizing legs can be deployed to the seabed to lift the installation vessel up a short distance to apply load stability during lifting operations. Seabed piles, mast elements, and turbine elements are delivered by barges that are temporarily moored between the pontoons for offloading and installation. Empty barges are relocated, and successive barges bring remaining elements for offloading and installation to complete the wind turbine installation. This arrangement of using separate, articulated tugboats or support vessels, allows the accommodation, propulsion, and power generation functions to be procured from the general marketplace and dramatically reduces build cost and operating costs.

The disclosure provides an installation vessel for an offshore wind turbine, comprising: at least two pontoons having a bow and a stern and adapted to float in water and separated by a distance; a bridge spanning the distance and coupling the two pontoons together, the bridge having an upwardly extending gantry with a height above the water; and a lifting system having a height above the gantry and coupled to an upper portion of the gantry, the lifting system positioned on the gantry to reach over an edge of the gantry into an installation zone formed between the two pontoons for lifting equipment from a barge in the installation zone. In at least one embodiment, the lifting system height plus the gantry height is sufficient to lift a wind turbine into position for installation but the lifting system height without the gantry height is insufficient to lift the wind turbine into position for installation. At least one support vessel is coupled to at least one of the pontoons wherein the support vessel provides motive force to the installation vessel. Advantageously, at least two pontoons each has a support vessel removably coupled thereto. At least one of the pontoons has a notch formed in the stern of the pontoon and adapted to fit a bow of the at least one support vessel. At least two stabilizer legs are coupled to the pontoons and adapted to be selectively deployed to engage a seabed.

The disclosure also provides a method of installing a wind turbine assembly using a vessel having at least two pontoons with a gantry and a lifting system coupled between the pontoons, the wind turbine assembly having a mast coupled to a turbine, the mast being coupled to a seabed pile, comprising: transporting at least one pile with a barge, positioning the barge between the pontoons, lifting a pile with the lifting system, installing the pile at least partially into the seabed, transporting one or more mast elements with the barge, positioning the barge between the pontoons, lifting the mast elements with the lifting system, positioning the mast elements on the top of the pile, transporting the turbine with blades on the barge, positioning the barge between the pontoons, lifting the turbine and the blades with the lifting system, and positioning the turbine with the blades on the top of the mast. Further, the barge can be repositioned between the pontoons or outside of the space between the pontoons after lifting one or more elements from the barge to allow sufficient room for the elements to be installed. The pile can be installed in several ways, including hammering the pile into position in the seabed. In some embodiments, at least one transition piece can be used between the pile and a mast element by transporting the transition piece on the barge, lifting the transition piece from the barge with the lifting system, and installing the transition piece on the top of the pile before installing the mast element on the pile.

### BRIEF DESCRIPTION OF THE SEVERAL VIEWS OF THE DRAWINGS

FIG. 1 is a schematic side view of an exemplary turbine installation vessel with support vessels coupled thereto.

FIG. 2 is a schematic top view of the turbine installation vessel and support vessels of FIG. 1.

FIG. 3 is a schematic top view of the turbine installation vessel and support vessels mobilized to an offshore installation site to install a wind turbine.

FIG. 4 is a schematic top view of the turbine installation vessel with one of the support vessels installing mooring lines.

FIG. 5 is a schematic side view of the turbine installation vessel with the deployed stabilizer legs.

FIG. 6 is a schematic top view of a first barge and a first tug mobilized to a quay having seabed piles and transition pieces stored thereby.

FIG. 7 is a schematic top view of piles and transition pieces loaded onto the first barge with the first tug located behind the barge.

FIG. 8 is a schematic top view of a second barge and a second tug mobilized to the quay after the first barge and first tug are moved away from the quay.

FIG. 9 is a schematic top view of piles and transition pieces loaded onto the second barge with the second tug located behind the barge.

FIG. 10 is a schematic top view of the installation vessel and the first barge with the piles and transitions pieces approaching the installation vessel.

FIG. 11 is a schematic top view of the installation vessel with the first barge positioned between the pontoons.

FIG. 12 is a schematic side view of the lifting system of the installation vessel lifting the pile from the first barge.

FIG. 13 is a schematic side view of the pile installed into the seabed with the installation vessel.

FIG. 14 is a schematic side view of the lifting system of the installation vessel lifting the transition piece from the first barge.

FIG. 15 is a schematic side view of the transition piece installed on the pile with the lifting system of the installation vessel.

FIG. 16 is a schematic top view of the installation vessel recovering the stabilizer legs to relocate to the next turbine installation site with the first barge and first tug.

FIG. 17 is a schematic top view of the installation vessel after installing a second pile and transition piece from the first barge and ready to receive the second barge and second tug for additional installations of piles and transition pieces in additional installation sites.

FIG. 18 is a schematic top view of the first barge and the first tug mobilized to a quay having turbine sub-assemblies, mast elements, and turbine blades stored thereby.

FIG. 19 is a schematic top view of mast elements loaded onto the first barge with the first tug located behind the barge.

FIG. 20 is a schematic top view of the second barge and the second tug mobilized to the quay after the first barge and first tug are moved away from the quay.

FIG. 21 is a schematic top view of turbine elements loaded onto the second barge with the second tug located behind the barge.

FIG. 22 is a schematic top view of the installation vessel and the first barge with the mast elements approaching the installation vessel.

FIG. 23 is a schematic top view of the installation vessel with the first barge positioned between the pontoons.

FIG. 24 is a schematic side view of the lifting system of the installation vessel lifting the first mast element from the first barge to be installed on the transition piece.

FIG. 25 is a schematic side view of the lifting system of the installation vessel lifting the second mast element from the first barge to be installed on the first mast element.

FIG. 26 is a schematic top view of the installation vessel and the second barge with a turbine sub-assembly and a separate turbine blade approaching the installation vessel.

FIG. 27 is a schematic side view of the lifting system of the installation vessel lifting the turbine sub-assembly from the second barge to be installed on the second mast element.

FIG. 28 is a schematic side view of the installation vessel with the wind turbine installed.

FIG. 29 is a schematic side view of the installation vessel, the second barge, and the second tug moved from the installed wind turbine.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location, and from time to time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. Where appropriate, some elements have been labeled with an alphabetic character after a number to reference a specific member of the numbered element to aid in describing the structures in relation to the Figures, but is not limiting in the claims unless specifically stated. When referring generally to such members, the number without the letter is used. Further, such designations do not limit the number of members that can be used for that function.

The disclosure provides a vessel with a double pontoon arrangement joined together with a central bridge creating an offset “H” arrangement. The bridge spans the pontoons and includes a gantry structure on top of which sits a lifting system. Articulated tugs provide accommodation, propulsion, and power to the main part of the installation vessel. Additional lifting devices can be installed within the gantry to provide further lifting capability. At least two stabilizing legs are provided along each pontoon. Once set up onsite, the stabilizing legs can be deployed to the seabed to lift the installation vessel up a short distance to apply load stability during lifting operations. Seabed piles, mast elements, and turbine elements are delivered by barges that are temporarily moored between the pontoons for offloading and installation. Empty barges are relocated, and successive barges bring remaining elements for offloading and installation to complete the wind turbine installation.

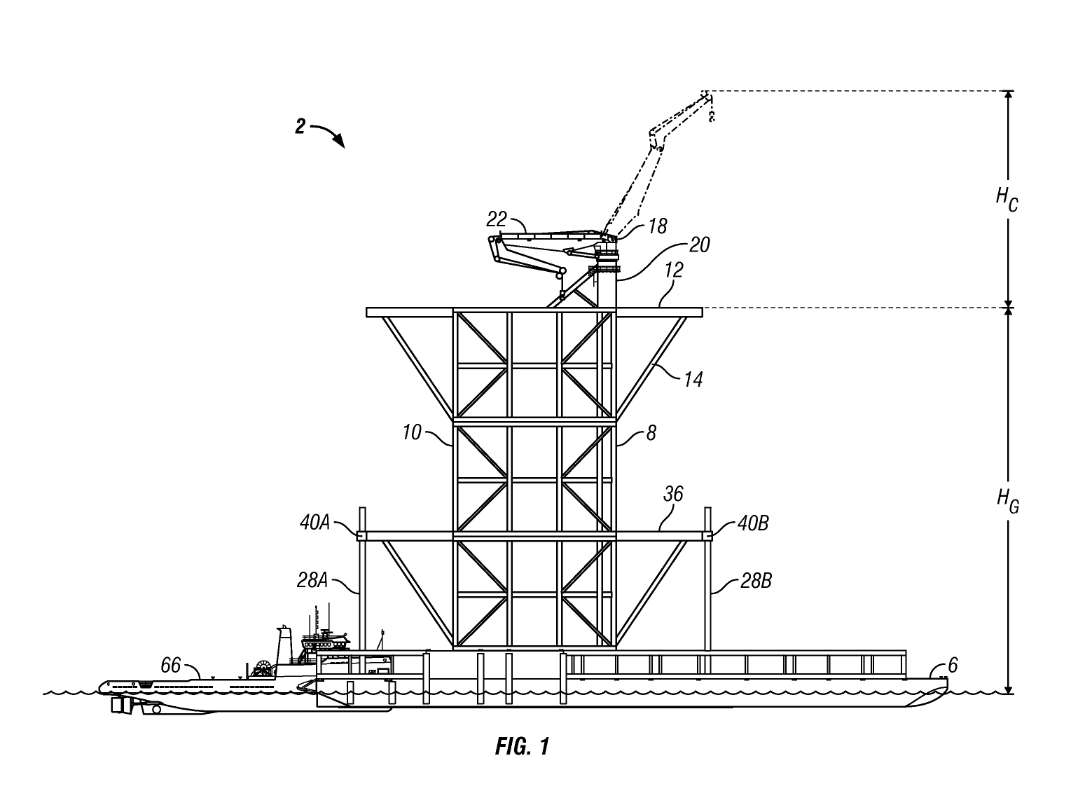

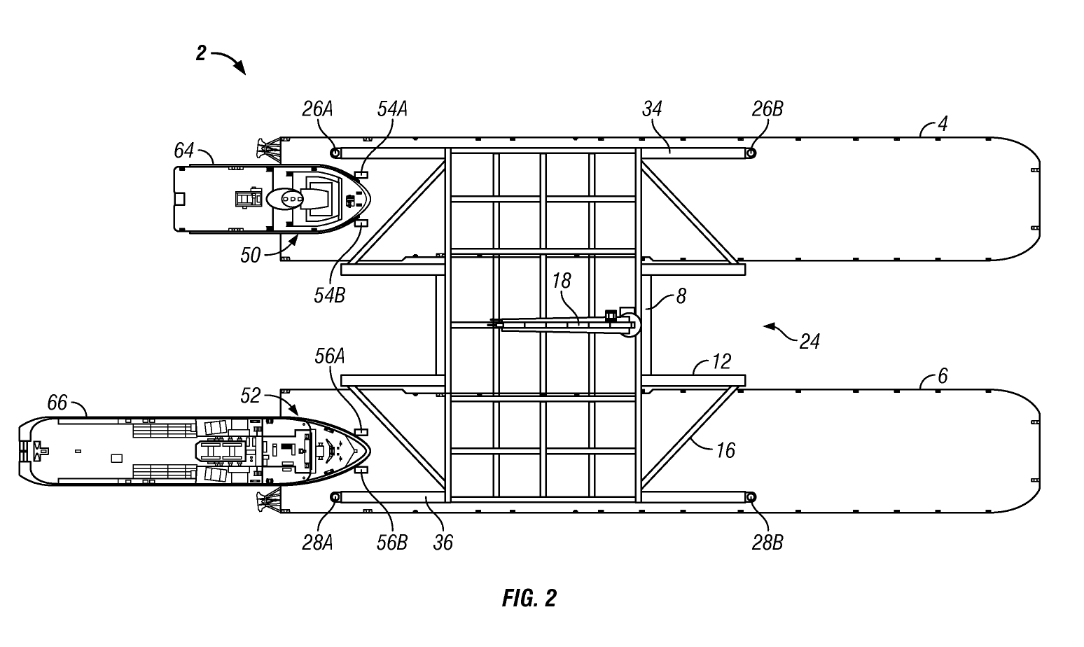

FIG. 1 is a schematic side view of an exemplary turbine installation vessel with support vessels coupled thereto. FIG. 2 is a schematic top view of the turbine installation vessel and support vessels of FIG. 1. The figures will be described in reference to each other. An installation vessel 2 includes two pontoons 4, 6 separated by a distance. The term “pontoon” is broadly defined to include pontoons, barges, and the like. A central bridge 8 spans the distance and joins the two pontoons 4, 6 together in order to obtain a catamaran shaped-design. The bridge 8 can be located at various points along the length of the pontoons and advantageously, so that the load being handled by a lifting system is disposed at about a center of gravity of the installation vessel. The lifting system can include a crane, an “A-frame” lift having two legs attached to the gantry and the top of the “A” actuated by a winch with a cable, as is known in the art, or other lifting devices. The lifting system will be illustrated as a crane with adjustments made for other types of lifting systems as needed. In at least one embodiment, the bridge with the pontoons creates an offset “H” arrangement from a top view and an upside down “T” arrangement from a side view. The bridge 4 can be coupled to the deck of each pontoon 4, 6, such as with two bases for each pontoon. The bridge 4 can include a truss structure forming a gantry 10 that extends to a height H_{G} above the water. A support member 12 with bracing 14 can be installed at the top of the gantry. Bracing 16 can be installed at some elevation to provide lateral rigidity.

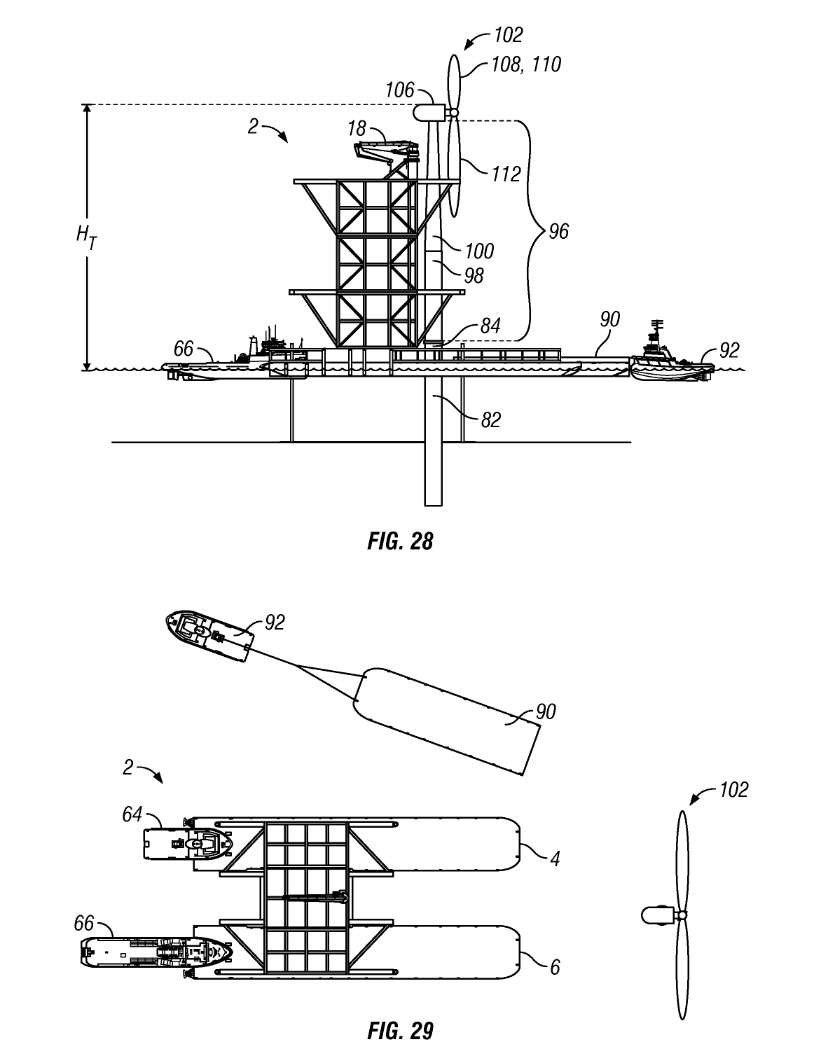

A lifting system 18 is coupled to an upper portion, generally the top, of the gantry 10. The lifting system has a height H_{C} that extends above the gantry 10. Advantageously, the lifting system can be relatively small compared to a typical lifting system of a surface vessel. The gantry at the height H_{G} is built to avoid requiring an expensive crane with a long reach when the crane is installed at a lower level, such as at the level of the pontoons. Thus, in at least one embodiment, the lifting system height H_{C} plus the gantry height H_{G} is sufficient to lift a wind turbine into position for installation to a height H_{T} (shown in FIG. 28), but the lifting system height H_{C} without the gantry height H_{G} is insufficient to lift the wind turbine into position for installation. This complementary height provides for efficiency and reduced lifting costs for installation of the wind turbine. The lifting system 18 is positioned generally near an edge of the gantry 10 to reach over the edge and lift items from between the pontoons in an installation zone 24 in the distance between the pontoons 4, 6 on the lifting system side of the gantry 10. The lifting system can include a pedestal 20 and a boom 22 for handling and lifting components around the installation vessel to install a wind turbine or other structures.

The pontoons 4,6 have at least two stabilizer legs 26A, 26B and 28A, 28B, respectively. These legs pass advantageously through the pontoons for load carrying capabilities. As shown FIG. 1, the legs 28A, 28B are in a raised position. The legs 26A, 26B and 28A, 28B can be coupled in a raised position to horizontal beams 34, 36, respectively, that can be coupled to the bridge 8. Further, the legs can be locked in position to the beams by locks 38A, 38B and 40A, 40B, respectively. A hydraulic or jacking system (not shown) can be used to move the legs 26A, 26B and 28A, 28B between a raised (retracted) position and a lowered (deployed) position.

The stern of the pontoons 4, 6 include a coupling section 50, 52, respectively, for support vessels to engage. The coupling sections 50, 52 can be shaped as a notch (and herein referenced as a “notch”) and sized to receive the bow of the support vessels 64, 66. However, the coupling sections 50, 52 can be shaped in any suitable shape that will allow the support vessels 64, 66 to be coupled to the installation vessel 2. The coupling sections 50, 52 have one or more couplers 54A, 54B and 56A, 56B, respectively, for removably coupling the support vessels to the pontoons 4, 6. Accommodation, propulsion, and power of the installation vessel 2 are provided by the support vessels 64, 66, which become part of the “installation vessel” when coupled thereto.

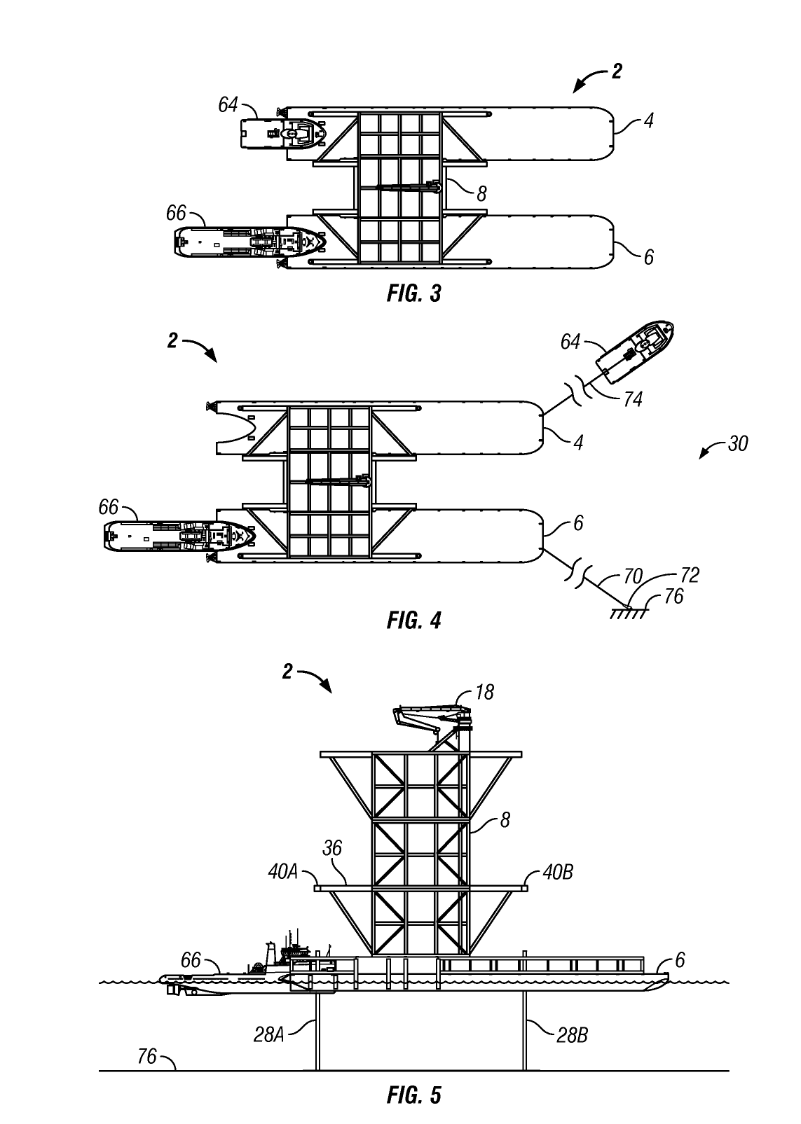

FIG. 3 is a schematic top view of the turbine installation vessel and support vessels mobilized to an offshore installation site to install a wind turbine generator. The two support vessels 64, 66 are coupled to the installation vessel 2 on the stern of each pontoon 4, 6. The support vessels provide motive force for the installation vessel to an offshore installation site and can use a hammer spread, known in the art (not illustrated).

FIG. 4 is a schematic top view of the turbine installation vessel with one of the support vessels installing mooring lines. At the offshore installation site 30, the first support vessel 64 is decoupled from the stern of the pontoon 4, and the second support vessel 66 stays coupled to the stern of the pontoon 6. The first support vessel 64 can install a first mooring line 70 having an anchor 72 that can be anchored to the seabed 76 and the other end of the mooring line coupled to the bow of the pontoon 6. The first support vessel 64 can also install a second mooring line 74 from the bow of the pontoon 4 in like manner.

FIG. 5 is a schematic side view of the turbine installation vessel with the deployed stabilizer legs. The stabilizer legs 26A, 26B can be moved from their raised (retracted) position shown in FIG. 1 to a lowered (deployed) position shown in FIG. 5. The legs are deployed to the seabed 76 and lift the installation vessel 2 by a short distance to create a supported load from the seabed for stability during lifting operations.

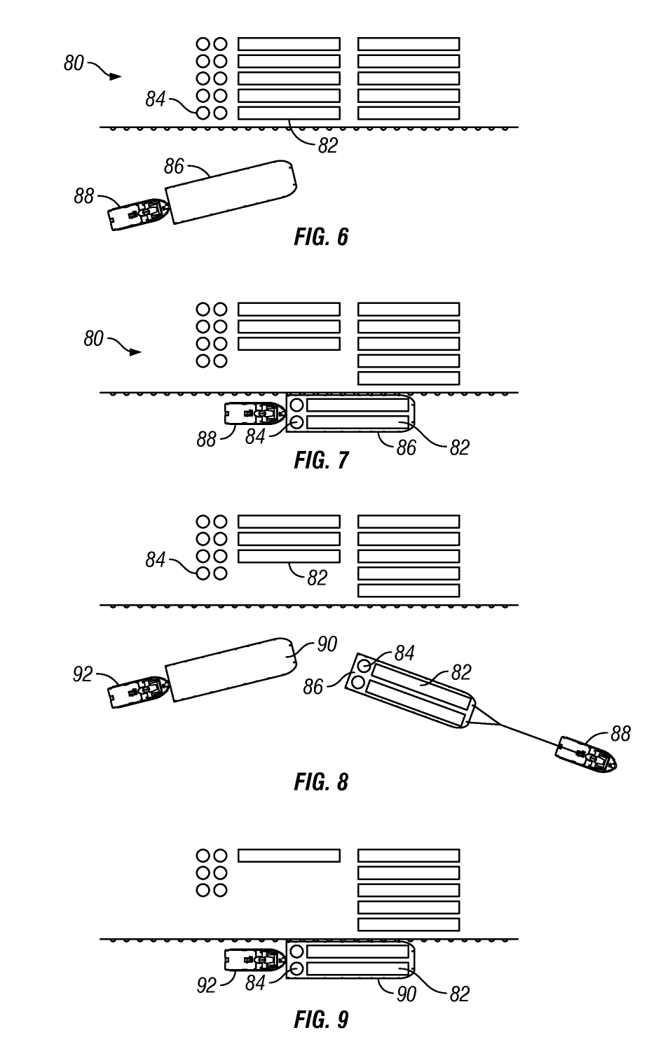

FIG. 6 is a schematic top view of a first barge and a first tug mobilized to a quay having seabed piles and transition pieces stored thereby. FIG. 7 is a schematic top view of piles and transition pieces loaded onto a first barge with a first tug located behind the barge. The figures will be described in conjunction with each other. One or more piles 82 and one or more transition pieces 84 are stored in the fabrication or storage yard by a quay 80. A first barge 86, pushed by a first tug 88, comes to load one or more piles 82 and one or more transition pieces 84. Depending on the size of the barge, more or less members can be loaded for a given loading.

FIG. 8 is a schematic top view of a second barge and a second tug mobilized to the quay after the first barge and first tug are moved away from the quay. FIG. 9 is a schematic top view of piles and transition pieces loaded onto the second barge with the second tug located behind the barge. The figures will be described in conjunction with each other. The first barge 86 is towed by the first tug 88 away from the quay and toward the offshore installation site. A second barge 90, pushed by a second tug 92, comes to load additional piles 82 and additional transition pieces 84. The second barge 90 can be pushed away from the quay, towed, or otherwise moved by the second tug 92 to the offshore installation site.

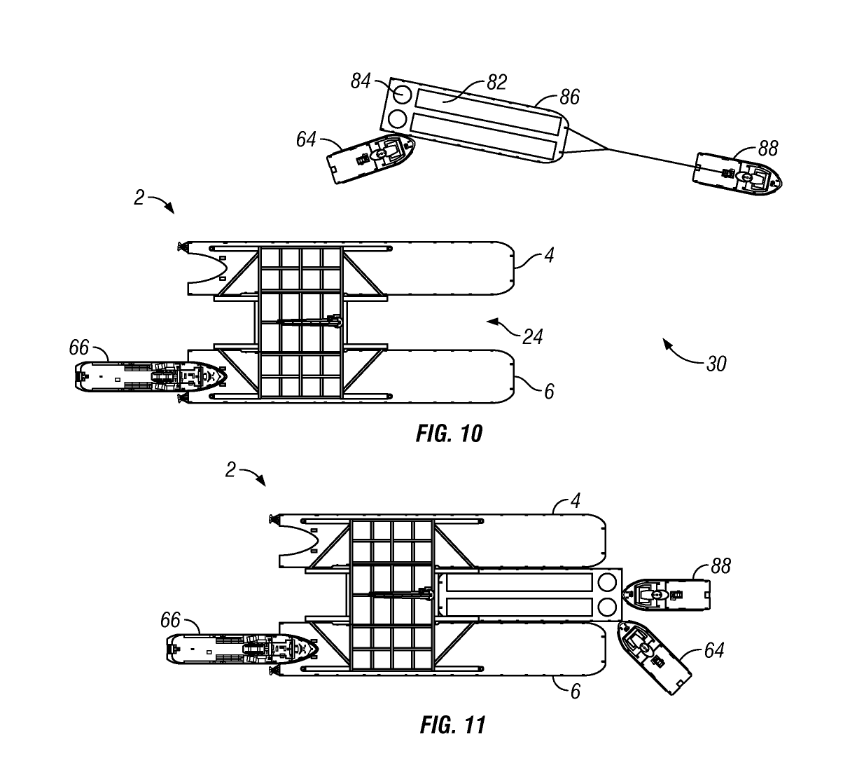

FIG. 10 is a schematic top view of the installation vessel and the first barge with the piles and transitions pieces approaching the installation vessel. FIG. 11 is a schematic top view of the installation vessel with the first barge positioned between the pontoons. The figures will be described in conjunction with each other. The first barge 86 with two piles 82 and two transition pieces 84 towed by the first tug 88 arrives at the offshore installation site 30. The tow lines are disconnected between the first barge 86 and the first tug 88. The tug 88 repositions to the stern of the first barge 86 to push the barge into the installation zone 24 between the two pontoons 4, 6. The tug 88 can be assisted by the first support vessel 64.

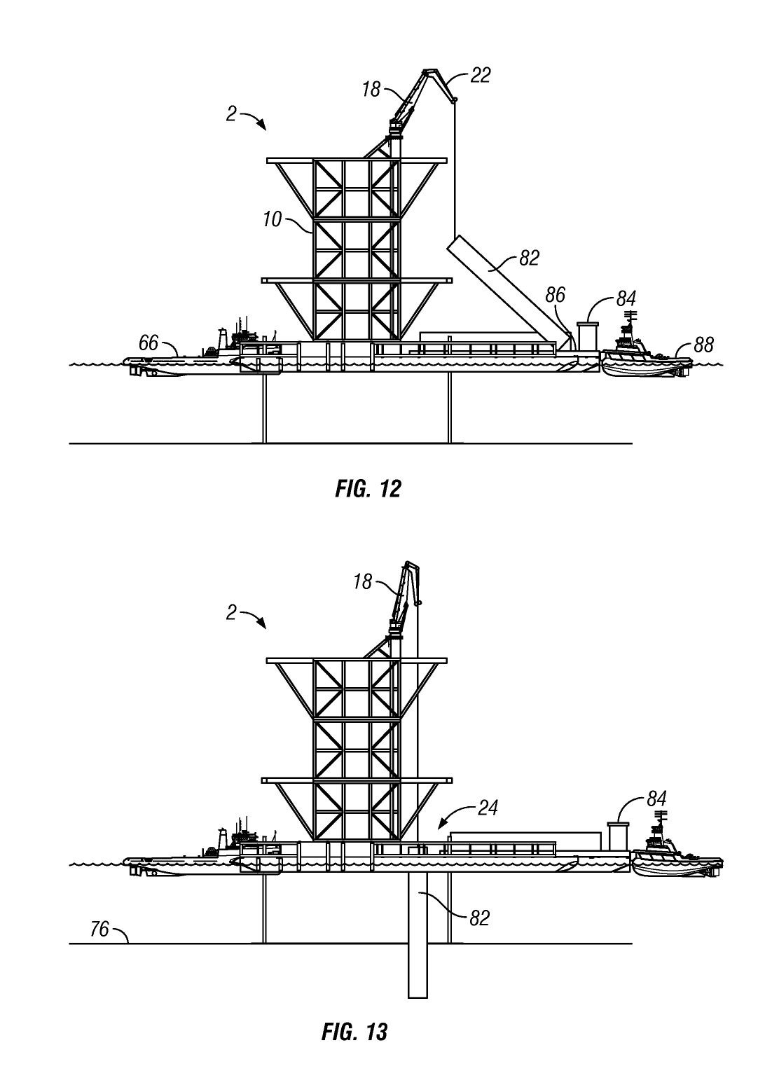

FIG. 12 is a schematic side view of the lifting system of the installation vessel lifting the pile from the first barge. FIG. 13 is a schematic side view of the pile installed into the seabed with the installation vessel. The figures will be described in conjunction with each other. The lifting system 18, on the top of the gantry 10 of the bridge, lifts one pile 82 from the first barge 86 to a vertical position and lowers the pile into position for installation into the seabed 76. The first barge 86 can be moved partially from the installation zone 24, if access is needed for the pile 82 to be lowered into position. The pile 82 is installed into the seabed 76, such as by hammering the pile into position.

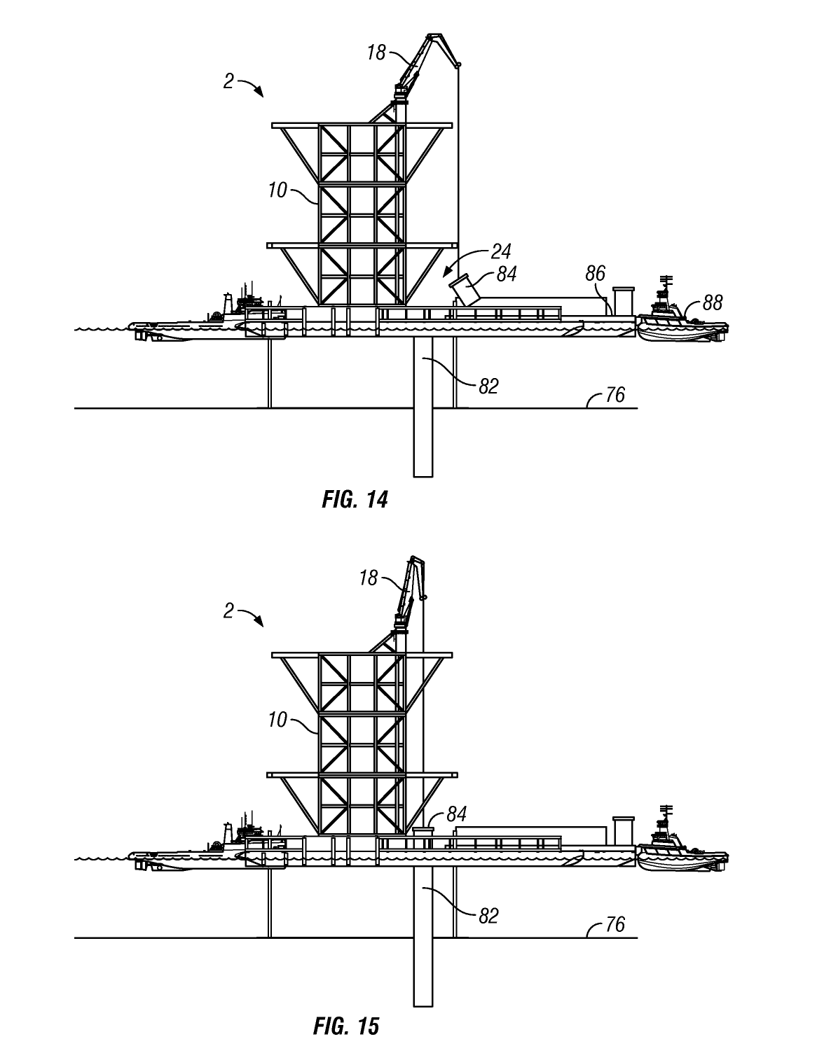

FIG. 14 is a schematic side view of the lifting system of the installation vessel lifting the transition piece from the first barge. FIG. 15 is a schematic side view of the transition piece installed on the pile with the lifting system of the installation vessel. The figures will be described in conjunction with each other. If necessary, the first barge 86 can be moved back into position in the installation zone 24. The lifting system 18 can lift the transition piece 84 from the first barge 86. The lifting system 18 can lower the transition piece 84 onto the top of the pile 84 that is anchored in the seabed. The transition piece can be grouted in position, if required.

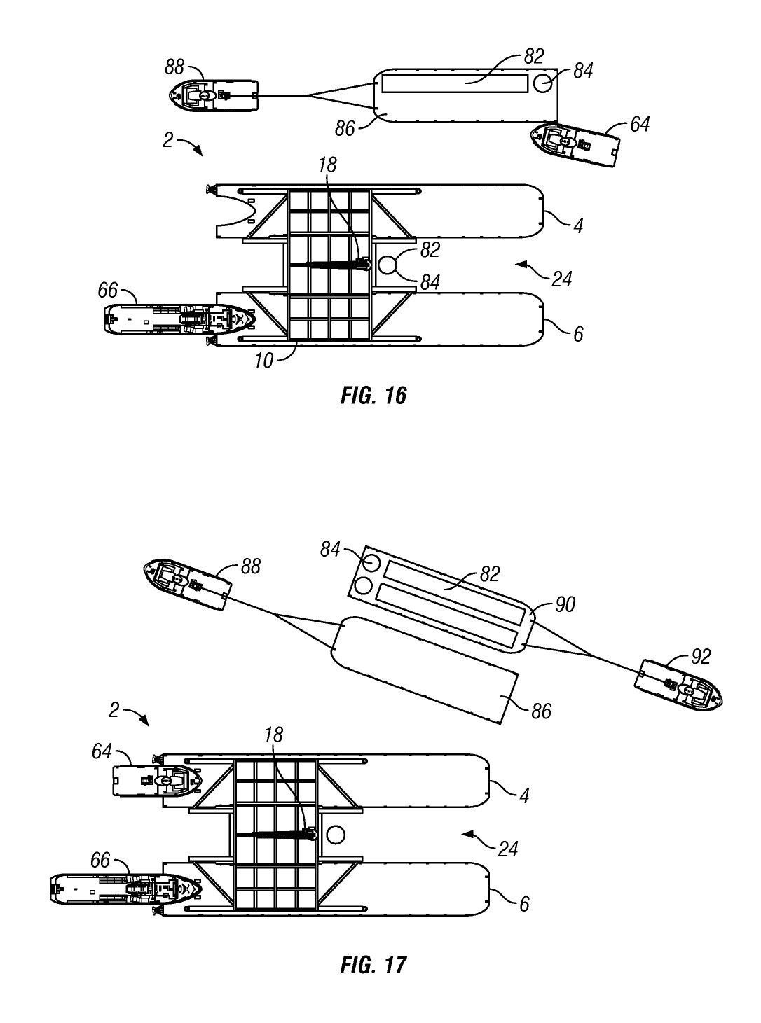

FIG. 16 is a schematic top view of the installation vessel recovering the stabilizer legs to relocate to the next turbine installation site with the first barge and first tug. When the first installation of the pile 82 and the transition piece 84 is finished, the first barge 86 can be relocated from the installation zone 24 between the pontoons 4, 6 with the first support vessel 64 assisting, if necessary. The two mooring lines 70, 74, shown in FIG. 4, are released, and the support vessel 64 returns to the stern of pontoon 4 to reposition itself within the notch 50, shown in FIG. 2. The stabilizer legs 26A, 26B and 28A, 28B are retracted, as shown in FIG. 1.

The installation vessel 2 moves to the next installation site. The first barge 86 with a remaining pile 82 and a remaining transition piece 84 are towed by the first tug 88 to the second offshore installation site. The first support vessel 64 decouples from the stern of the pontoon 4, and the second support vessel 66 stays coupled to the stern of the pontoon 6. The first support vessel 64 installs mooring lines to the pontoons, as described in reference to FIG. 4. The stabilizer legs 26A, 26B and 28A, 28B are deployed to the seabed and used to raise the installation vessel for stability, as described in reference to FIG. 5.

As at the first installation site, the tug 88 repositions to the stern of the first barge 86 to push the barge into the installation zone 24 between the two pontoons 4, 6 and can be assisted by the first support vessel 64. The lifting system 18, on the top of the gantry 10, lifts the next pile 82 from the first barge 86 to a vertical position and lowers the pile into position for installation into the seabed 76 with the first barge 86 being moved, if access is needed for the pile 82 to be lowered into position. The pile 82 is installed into the seabed 76. The lifting system 18 can lift the transition piece 84 from the first barge 86 and lower it over the pile 82. The transition piece 84 can be grouted as required. When the installation of the second pile 82 and the second transition piece 84 is finished, the first barge 86 is relocated from the installation zone 24 between the pontoons 4,6. The first barge 86 can be returned empty to the yard to load more piles 82 and more transition pieces 84 for more installation sites. Alternatively, if all the piles and transitions pieces have been installed at the planned installation sites, the barge 86 can load mast elements and wind turbine elements and return to one or more of the installation sites for the next phase of installations.

FIG. 17 is a schematic top view of the installation vessel after installing a second pile and transition piece from the first barge and ready to receive the second barge and second tug for additional installations of piles and transition pieces in additional installation sites. The installation vessel can move to another installation site. The second barge 90, towed by the second tug 92, can provide the pile and transition piece for the next site. The installation process is repeated as described above and the piles and transition pieces are installed at other sites. The first and second barges 86, 90 can alternatively supply the piles 82 and transitions pieces 84 to complete the installations of such elements at the various installation sites.

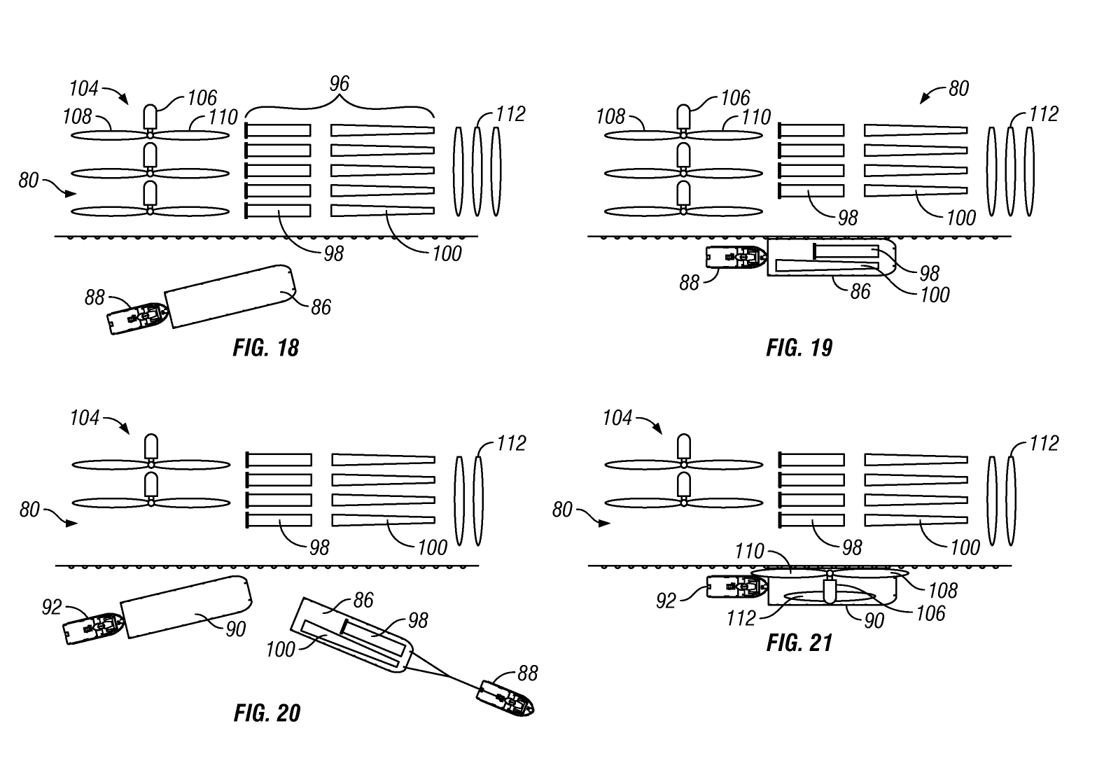

The installation and the transport of the mast of the wind turbine is similar as described above for the pile and transition piece. In at least one embodiment, the mast includes two mast elements, and the wind turbine includes a sub-assembly of a turbine and two preinstalled blades with an additional separate blade to be installed at the site. The process is illustrated in FIGS. 18-29.

FIG. 18 is a schematic top view of the first barge and the first tug mobilized to a quay having turbine sub-assemblies, mast elements, and turbine blades stored thereby. FIG. 19 is a schematic top view of mast elements loaded onto the first barge with the first tug located behind the barge. The figures will be described in conjunction with each other. One or more mast elements and wind turbine elements are stored in the fabrication or storage yard by the quay 80. Generally, installation of elements onshore is easier and more efficient, and it is generally beneficial to minimize the number of separate elements for installation offshore, depending on size and transportation capabilities. In the exemplary, non-limiting embodiment, a mast 96 can include a first mast element 98 and a second mast element 100. In the exemplary, non-limiting embodiment, a three-bladed wind turbine can have one or more of the three blades preinstalled prior to transportation to the installation site. For example, a wind turbine 106 can be coupled with two blades 108, 110, as a turbine sub-assembly 104, prior to loading onto a barge for transportation to the installation site. The two blades projecting upward at an angle without the third blade projecting downward allow the turbine 106 to be securely stored on the barge during transportation. The separate third blade 112 can be loaded onto the barge with the turbine sub-assembly for installation at the site.

More specifically, a first barge 86, pushed by a first tug 88, comes to load one or more masts 96. In this example, the mast 96 includes a first mast element 98 and a second mast element 100. Both mast elements 98, 100 can be loaded onto the barge 86 for transportation to an offshore installation site. Depending on the size of the barge, more or less elements can be loaded for a given loading.

FIG. 20 is a schematic top view of the second barge and the second tug mobilized to the quay after the first barge and first tug are moved away from the quay. FIG. 21 is a schematic top view of turbine elements loaded onto the second barge with the second tug located behind the barge. The figures will be described in conjunction with each other. The first barge 86 is towed by the first tug 88 away from the quay 80 and toward the offshore installation site. A second barge 90, pushed by a second tug 92, comes to load the turbine elements, including a turbine sub-assembly 104 and a blade 112. The second barge 90 can be pushed away from the quay, towed, or otherwise moved by the second tug 92 to the offshore installation site.

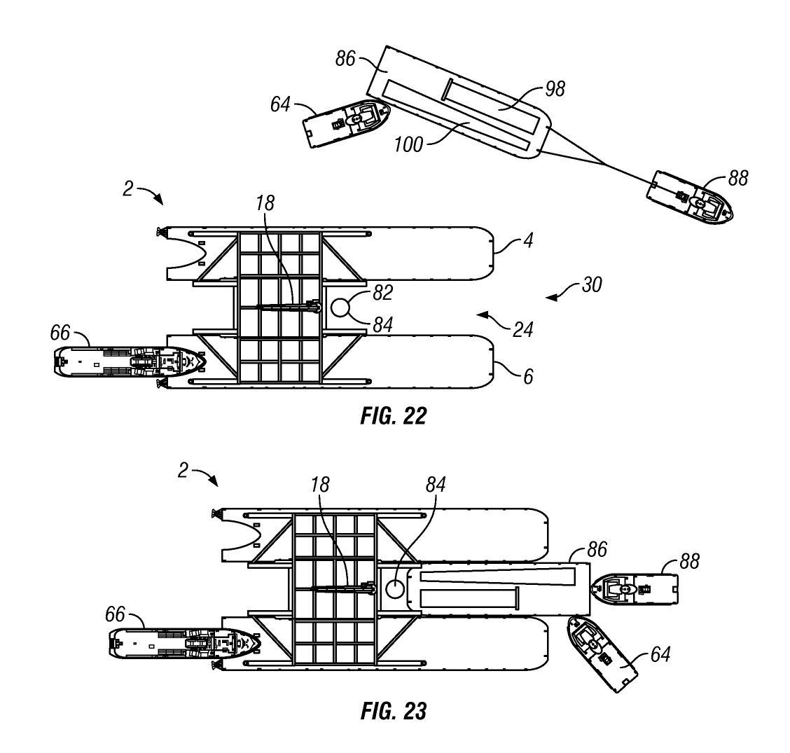

FIG. 22 is a schematic top view of the installation vessel and the first barge with the mast elements approaching the installation vessel. FIG. 23 is a schematic top view of the installation vessel with the first barge positioned between pontoons. The figures will be described in conjunction with each other. The first barge 86 with two mast elements 98, 100 is towed by the first tug 88 and arrives at the offshore installation site 30. The tow lines are disconnected between the first barge 86 and the first tug 88. The tug 88 repositions to the stern of the first barge 86 to push the barge into the installation zone 24 between the two pontoons 4, 6. The tug 88 can be assisted by the first support vessel 64.

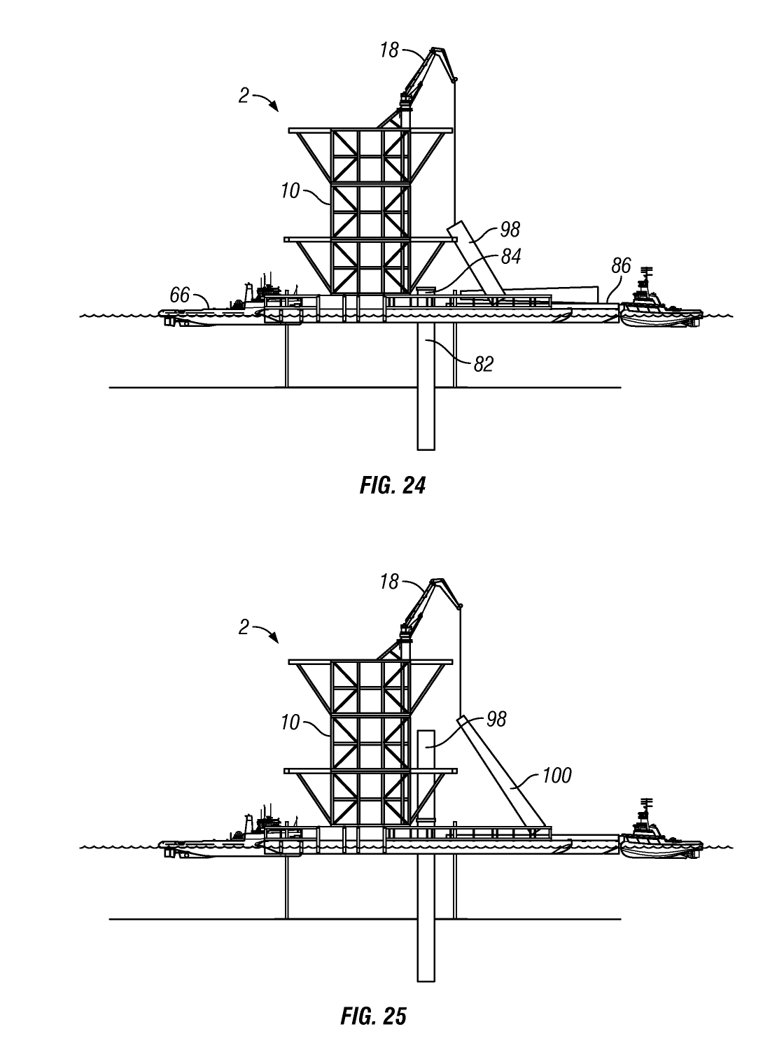

FIG. 24 is a schematic side view of the lifting system of the installation vessel lifting the first mast element from the first barge to be installed on the transition piece. FIG. 25 is a schematic side view of the lifting system of the installation vessel lifting the second mast element from the first barge to be installed on the first mast element.

The figures will be described in conjunction with each other. The lifting system 18, on the top of the gantry 10, lifts the first mast element 98 from the first barge 86 to a vertical position and lowers the first mast element into position for coupling with the transition piece 84. After coupling the first mast element 98 to the transition piece 84, the lifting system 18 can lift the second mast element 100 from the first barge 86. The lifting system 18 can lower the second mast element 100 into position for coupling to the top of the first mast element 98.

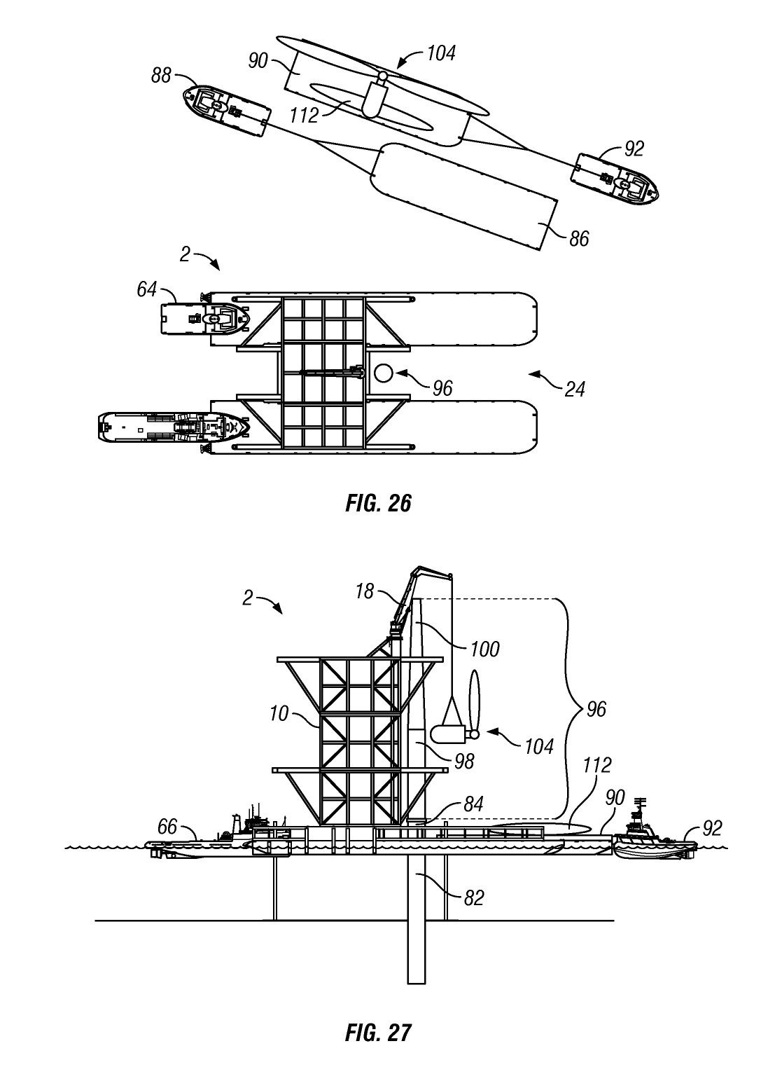

FIG. 26 is a schematic top view of the installation vessel and the second barge with the turbine sub-assembly and turbine blade approaching the installation vessel. The first barge 86 is empty and can be relocated out of the installation zone 24 with the tug 88 and the support vessel 64 if required. The first barge can be returned to the quay for loading of additional elements. The second barge 90 with the wind turbine elements, such as the turbine sub-assembly 104 with the preinstalled two blades and the separate third blade 112, can be moved by the tug 92 into the installation zone 24 for installation on the mast 96.

FIG. 27 is a schematic side view of the lifting system of the installation vessel lifting the turbine sub-assembly from the second barge to be installed on the second mast element. The figures will be described in conjunction with each other. The lifting system 18, on the top of the gantry 10, lifts the turbine sub-assembly 104 from the second barge 90 into position for coupling with the mast 96, such as on the second mast element 100. After coupling the turbine sub-assembly 104 to the mast 96, the lifting system 18 can lift the blade 112 from the second barge 90 for coupling with the turbine sub-assembly 104. Alternatively, the lifting system 18 can partially lift the turbine sub-assembly 104 to an intermediate position supported by some structure and then lift the blade 112 into position for coupling to the turbine sub-assembly and then lift the entire assembly into position for coupling with the mast 96. Other variations are possible.

FIG. 28 is a schematic side view of the installation vessel with the wind turbine installed. The installation of the wind turbine 102 is finalized, electrical and other components are installed, and operational capabilities of the wind turbine are confirmed. The installation vehicle 2 begins preparations for movement to the next site.

FIG. 29 is a schematic side view of the installation vessel, the second barge, and the second tug moved from the installed wind turbine. The second barge 90 is moved by the tug 92 away from the installation vessel 2. The stabilizer legs of the installation vessel are retracted, and the mooring lines are released. The support vessels 64 and 66 move the installation vessel 2 away from the installed wind turbine 102. If other sites remain that need installation of wind turbine elements, then the second barge 90 can be returned to the quay for loading further elements, and the process is repeated.

Advantageously, the installation vessel reduces the costs of installation by using the gantry bridge which has significant height. The gantry also allows use of a smaller and cheaper lifting system. Moreover, although one vessel can be used to move the installation vessel, dual support vessels provide operational and construction flexibility. One vessel on station can support the construction operation while the other support vessel undertakes installation of mooring lines, assisting in incoming and outgoing barge maneuvering, cable jumper installation, spare propulsion, and other needs.

Another advantage is the ability to switch from the installation of multiple piles at different installation sites in a batch process, to a complete mast and turbine installation at a given site. Alternatively, the installation vessel could also install the mast elements at multiple installation sites as was described for the piles before installing the turbine elements at a given site. Further, it is understood that the process of installing the piles and transition pieces is exemplary and non limiting. For example, the barges can bring components to the installation vessel at one installation site to complete the installation of the entire wind turbine before the installation vessel moves to the next installation site.

Other and further embodiments utilizing one or more aspects of the invention described above can be devised without departing from the spirit of the invention. For example, in some embodiments, a transition piece may not be used. Thus, the mast could be installed to the pile without the transition piece, or alternatively, the transition piece could be precoupled to the mast or made integral therewith, so that a separate lifting and installation of the transition piece is not performed. Still further, the mast can be formed in different numbers of elements from one to many. Thus, the illustrative embodiments are merely examples and non-limiting, and reflect some consideration of current economics and sizes, which can change. Other variations in the system are possible.

Further, the various methods and embodiments described herein can be included in combination with each other to produce variations of the disclosed methods and embodiments. Discussion of singular elements can include plural elements and vice-versa. References to at least one item followed by a reference to the item may include one or more items. Also, various aspects of the embodiments could be used in conjunction with each other to accomplish the understood goals of the disclosure. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The invention has been described in the context of preferred and other embodiments and not every embodiment of the invention has been described. Apparent modifications and alterations to the described embodiments are available to those of ordinary skill in the art given the disclosure contained herein. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope or range of equivalent of the following claims.

What is claimed is:

1. An installation vessel for an offshore wind turbine, comprising:
at least two pontoons having a bow and a stern and adapted to float in water and separated by a distance;
a bridge spanning the distance and coupling the two pontoons together, the bridge having an upwardly extending gantry with a height above the water; and
a lifting system having a height above the gantry and coupled to an upper portion of the gantry, the lifting system positioned on the gantry to reach over an edge of the gantry into an installation zone formed between the two pontoons for lifting equipment from a barge in the installation zone.

2. The installation vessel of claim 1, wherein the lifting system height plus the gantry height is sufficient to lift a wind turbine into position for installation, but the lifting system height without the gantry height is insufficient to lift the wind turbine into position for installation.

3. The vessel of claim 1, further comprising at least one support vessel coupled to at least one of the pontoons wherein the support vessel provides motive force to the installation vessel.

4. The vessel of claim 3, wherein at least one of the pontoons has a notch formed in the stern of the pontoon and adapted to fit a bow of the at least one support vessel.

5. The vessel of claim 5, further comprising at least two support vessels removably coupled to the at least two pontoons.

6. The vessel of claim 1, further comprising at least two stabilizer legs coupled to the pontoons and adapted to be selectively deployed to engage a seabed.

7. The vessel of claim 1, further comprising at least two locks coupled to a beam on the gantry and adapted to lock the at least two stabilizer legs in a selected position.

8. A method of installing a wind turbine assembly using a vessel having at least two pontoons with a gantry and a lifting system coupled between the pontoons, the wind turbine assembly having a mast coupled to a turbine, the mast being coupled to a seabed pile, comprising:
transporting at least one pile with a barge;
positioning the barge between the pontoons;
lifting a pile with the lifting system;
installing the pile at least partially into the seabed;
transporting a mast comprising one or more mast elements with the barge;
positioning the barge between the pontoons;
lifting the mast elements with the lifting system;
installing the mast elements on the top of the pile;
transporting the turbine with blades on the barge;
positioning the barge between the pontoons;
lifting the turbine and the blades with the lifting system; and
installing the turbine with the blades on the top of the mast.

9. The method of claim 8, further comprising repositioning the barge between the pontoons or outside of an installation zone between the pontoons after lifting one or more elements from the barge to allow sufficient room for the elements to be installed.

10. The method of claim 8, further comprising hammering the pile into position in the seabed.

11. The method of claim 8, further comprising installing a transition piece between the pile and the mast.

12. The method of claim 11, wherein installing the transition piece comprises:
transporting the transition piece on the barge;
lifting the transition piece from the barge with the lifting system; and
installing the transition piece on the top of the pile before installing the mast on the pile.
